(19) United States
(12) Patent Application Publication
(10) Pub. No.: US 2026/0311073 A1
(43) Pub. Date: Oct. 8, 2026

(54) COMMUNICATION SERVER, A METHOD, A BOOKING DEVICE, AND A SYSTEM

(71) Applicant: GP NETWORK ASIA PTE. LTD., Singapore (SG)

(72) Inventor: Tanay Kumar BERA, Bengaluru (IN)

(73) Assignee: GP NETWORK ASIA PTE. LTD., Singapore, SG (SG)

(21) Appl. No.: 19/479,492

(22) PCT Filed: Jun. 28, 2024
(86) PCT No.: PCT/SG2024/050426

§ 371 Date: Oct. 28, 2025

(30) Foreign Application Priority Data
Jun. 28, 2023 (SG) 10202301862P

(51) Int. Cl. G06Q 10/02; G06Q 50/40

(52) U.S. Cl. CPC G06Q 10/0283; G06Q 50/40

(57) ABSTRACT

A communication server apparatus 102 for booking a transportation service, the communication server comprising a processor 116 and a memory 118, the communication server apparatus 102 being configured, under control of the processor 116, to execute instructions 120 stored in the memory 118, to: store in the memory, a plurality of users, wherein one or more users having an associated payment method, and one or more of the one or more users having an associated payment method having an at least one associated unique non-payment passenger identifier, each associated unique non-payment passenger identifier having at least one predetermined destination address, store in the memory a plurality of booking communication devices, each booking communication device having a predetermined pickup location, receive one of the plurality of unique non-payment passenger identifiers, presented to one of the plurality of booking communication devices in relation to a booking, determine using the processor an optimal transport solution for the booking based on at least the predetermined pickup location of the booking communication device, and on the predetermined destination address retrieved from the memory, and initiate payment for the booking using the payment method associated with the respective user for the unique non-payment passenger identifier. Also a method, a booking communication device, and a communication system.

### TECHNICAL FIELD

The invention relates generally to the field of communication. One aspect of the invention relates to a communication server apparatus for booking a transportation service. Another aspect of the invention relates to a method, performed in a communication server apparatus for booking a transportation service. Another aspect of the invention relates to a booking communication device for booking a transportation service. Another aspect of the invention relates to a communication system.

### BACKGROUND

Various forms of transportation booking systems exist.

For example, US20180376277 describes a system which uses a customer's payment card to book a cab at an ATM/POS, which is set as the pick-up location. US20180091930 also discloses a card and reader system which can be used for booking a rental car. US20200298841 discloses a user safety system for shared ride systems. CN111612187 discloses a user having a UWB tag, and a user terminal for booking a taxi. One technical problem that may exist in the art is how to reduce susceptibility of fraud. Another technical problem that may exist in the art is how to allow unregistered users, to book transport, using a transportation system.

### SUMMARY

Embodiments may be implemented as set out in the independent claims. Some optional features are defined in the dependent claims.

Implementation of the techniques disclosed herein may provide significant technical advantages. Advantages of one or more aspects may include:
allow unregistered sub users to book transport, such as children or older relatives;
allow unregistered sub users to book transport simply without needing to use a phone, an app or needing to understand technology;
allow the user to manage how much sub users can spend, or from where, or to where, transport can be booked;
easy disabling of tokens if lost by sub users; and/or
easy automatic detection of fraud if an unauthorised user, uses the token outside of the allowed criteria.

In at least some implementations, the techniques disclosed herein may allow for:
the technical solution of reduced greenhouse emissions based on the technical problem of unregistered users booking transport. Because the bookings are limited to those preauthorised by the user, there may be less wasted trips by drivers, or less wasted sales by merchants, and therefore greenhouse emissions for any unnecessary trips or unnecessary product manufacturing may be avoided;
the technical solution of reduced data centre energy requirements based on the technical problem of unregistered users booking transport. Because the bookings are limited to those preauthorised by the user, no unauthorised bookings are permitted and therefore less energy is required for powering the servers and/or for cooling the servers;
the technical solution of reduced server hardware required for the technical problem of unregistered users booking transport. Because bookings are limited to those preauthorised by the user no unauthorised bookings are permitted, so less hardware is required;
the technical solution of reduced bandwidth requirements based on the technical problem of unregistered users booking transport. Because bookings are limited to those preauthorised by the user no unauthorised bookings are permitted, so and less bandwidth is required for communications;
the technical solution of faster booking of transport for the technical problem of unregistered users without themselves personally having an automated payment method; and/or
the technical solution of reduction of fraud based on the technical problem of unregistered users booking transport. The system can automatically detect fraud by unauthorised users, or the user may disable tokens if they are lost. In an exemplary implementation, the functionality of the techniques disclosed herein may be implemented in software running on a server communication apparatus (such as a cluster of servers or a cloud computing platform), which communicates with the applications running on the terminals, such as mobile phones. The software which implements the functionality of the techniques disclosed herein may be contained in a computer program, or computer program product. The server communication apparatus establishes secure communication channels with the user terminals for managing the unregistered sub users and associated tokens. The process also includes the processing of bookings, fetching data from databases and execution of an optimal transport solution.

### BRIEF DESCRIPTION OF THE DRAWINGS

The invention will now be described, by way of example only, and with reference to the accompanying drawings in which:

FIG. 1 is a schematic block diagram illustrating an exemplary delivery/transportation service.

FIG. 2 is a schematic block diagram illustrating an exemplary communications server for the delivery/transportation service.

FIG. 3 is a schematic flow diagram illustrating an exemplary process for user registration.

FIG. 4 is a schematic block diagram illustrating an exemplary POS hardware scheme.

FIG. 5 is a schematic flow diagram illustrating an exemplary secondary user flow.

### DETAILED DESCRIPTION

The techniques described herein are described primarily with reference to use in booking transport for applications including, but not limited to, food deliveries, online groceries taxi, ride hailing, ride sharing, tickets, attractions, vouchers, service/trade exchanges, and pet transport. It will be appreciated that these techniques may have a broader reach and may be usefully implemented in other fields where booking transport may be required. Generally, this might be the case in any transport system.

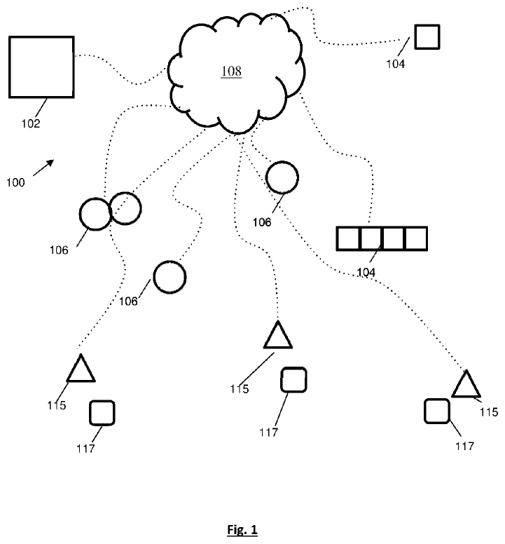

FIG. 1 shows an exemplary architecture of a delivery/transportation service system 100, with a number of users each having a communications device 104, a number of drivers each having a user interface communications device 106, a number of booking communication devices 115, a server 102 (or geographically distributed servers) and communication network 108 connecting each of the components. Each user contacts the server 102 using a user software application (app) on the communications device 104.

For deliveries, the user app may allow the users to input queries containing the keywords for the items of interest and delivery addresses. The user may see a list of merchants and/or items provided by the merchants, and order items from the merchants. The merchants contact the server 102 using the merchant app for providing the information about their items and receiving orders for each confirmed transaction. The drivers contact the server 102 using the driver app on the communication device 106. The driver app allows the drivers to indicate their availability to take the delivery jobs, information about their vehicle, their location. The server 102 may then match the orders to drivers, based on, for example, geographic location of the drivers, merchant addresses and delivery addresses, driving conditions, traffic level/accidents, demands and supplies, etc.

For transportation, the user app may allow the user to enter their pick-up location, a destination address, one or more service parameters, and/or after-ride information such as a rating. The one or more service parameters may include the number of seats of the vehicle, the style of vehicle, level of environmental impact and/or what kind of transport service is desired. Each driver contacts the server 102 using a driver app on the communication device 106. The driver app allows the driver to indicate their availability to take the ride jobs, information about their vehicle, their location, and/or after-ride info such as a rating. The server 102 may then match users to drivers, based on, for example: geographic location of users and drivers, maximising revenue, user or driver feedback ratings, weather, driving conditions, traffic level/accidents, relative demand, environmental impact, and/or supply levels. This allows an efficient allocation of resources because the available fleet of drivers is optimised for the users' demand in each geographic zone.

Further the system may allow unregistered sub-users, each sub-user preauthorised by a registered user, to book using a booking communication device 115 using a token 117. Each booking communication device 115 may be located in a high demand location.

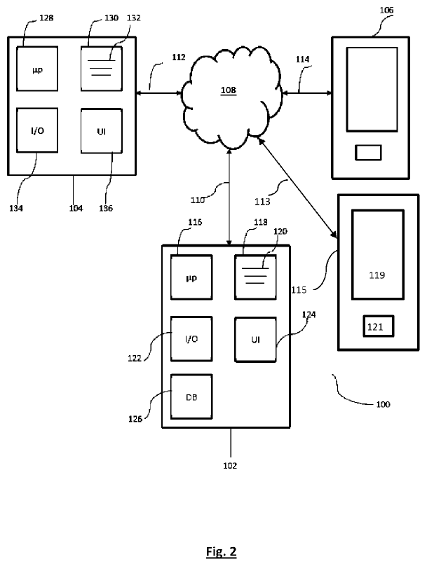

Referring to FIG. 2, further details of the components in the system of FIG. 1 are now described. The communication apparatus 100 comprises the communication server 102, and it may include the user communication device 104, and the driver communication device 106. These devices are connected in the communication network 108 (for example, the Internet) through respective communication links 110, 112, 113, 114 implementing, for example, internet communication protocols. The communication devices 104 and 106 may be able to communicate through other communication networks, including mobile cellular communication networks, private data networks, fibre optic connections, laser communication, microwave communication, satellite communication, etc., but these are omitted from FIG. 2 for the sake of clarity.

The communication server apparatus 102 may be a single server as illustrated schematically in FIG. 2. Alternatively, the functionality performed by the server apparatus 102 may be distributed across multiple physically or logically separate server components. In the example shown in FIG. 2, the communication server apparatus 102 may comprise a number of individual components including, but not limited to, one or more microprocessors 116, a memory 118 (e.g. a volatile memory such as a RAM, and/or longer term storage such as SSD (Solid State or Hard disk drives (HDD)) for the loading of executable instructions 120, the executable instructions defining the functionality the server apparatus 102 carries out under control of the microprocessor 116. The communication server apparatus 102 also comprises an input/output module 122 allowing the server to communicate over the communication network 108. User interface 124 is provided for user control and may comprise, for example, computing peripheral devices such as display monitors, computer keyboards and the like. The server apparatus 102 also comprises a database 126, the purpose of which will become readily apparent from the following discussion.

The user communication device 104 may comprise a number of individual components including, but not limited to, one or more microprocessors 128, a memory 130 (e.g., a volatile memory such as a RAM) for the loading of executable instructions 132, the executable instructions defining the functionality the user communication device 104 carries out under control of the microprocessor 128. The user communication device 104 also comprises an input/output module 134 allowing the user communication device 104 to communicate over the communication network 108. A user interface 136 is provided for user control. If the user communication device 104 is, say, a smartphone or tablet device, the user interface 136 will have a touch panel display as is prevalent in many smartphones and other handheld devices. Alternatively, if the user communication device 104 is, say, a desktop or laptop computer, the user interface 136 may have, for example, computing peripheral devices such as display monitors, computer keyboards and the like.

The driver communication device 106 may be, for example, a smartphone or tablet device with the same or a similar hardware architecture to that of the user communication device 104. Alternatively, the functionality may be integrated into a bespoke device such as a taxi fleet management terminal.

The booking communication device 115 may include a user interface 119 and a token reader 121. When a sub-user presents their token 117 to the token reader 121, the booking communication device 115 will verify the unique non-payment passenger identifier stored in the token using the communication link 113 to the server 102. Based on this, the user interface 119 will display at least one predetermined destination address from database 126 associated with the unique non-payment passenger identifier. The sub-user can then use the user interface 119 to confirm a booking based on the destination address and the pickup address associated with the respective booking communication device 115. The server will determine an optimal transport solution, and provide instructions to the driver communication device 106 and to the booking communication device 115. The user communication device 104 may be updated with the booking, when the transport is ongoing, when the transport is complete, and/or once payment has been made from the user's payment method.

Thus, it will be appreciated that FIGS. 1 and 2 and the foregoing description illustrate and describe a communication server apparatus 102 comprising a microprocessor 116 and a memory 118, the communication server apparatus 102 being configured, under control of the microprocessor 116, to execute instructions 120 stored in the memory 118, to:
store in the memory, a plurality of users, wherein one or more users having an associated payment method, and one or more of the one or more users having an associated payment method having an at least one associated unique non-payment passenger identifier, each associated unique non-payment passenger identifier having at least one predetermined destination address,
store in the memory a plurality of booking communication devices, each booking communication device having a predetermined pickup location,
receive one of the plurality of unique non-payment passenger identifiers, presented to one of the plurality of booking communication devices in relation to a booking,
determine using the processor an optimal transport solution for the booking based on at least the predetermined pickup location of the booking communication device, and on the predetermined destination address retrieved from the memory, and
initiate payment for the booking using the payment method associated with the respective user for the unique non-payment passenger identifier.

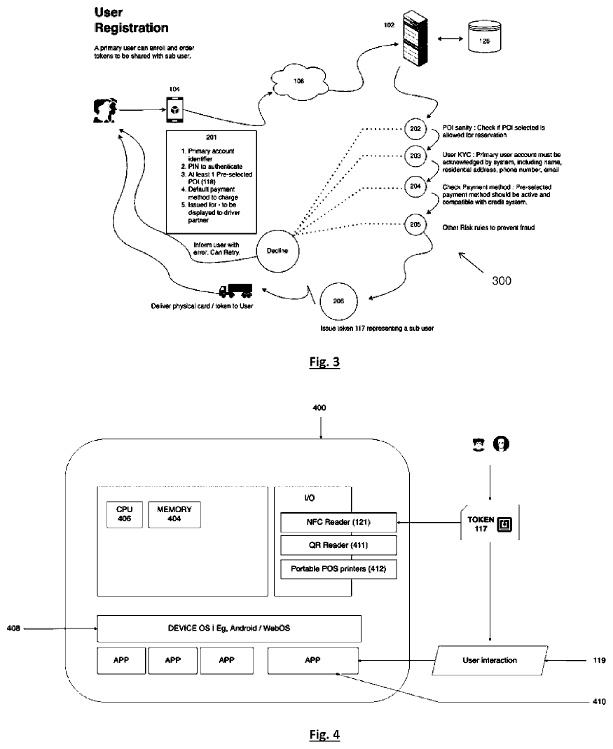

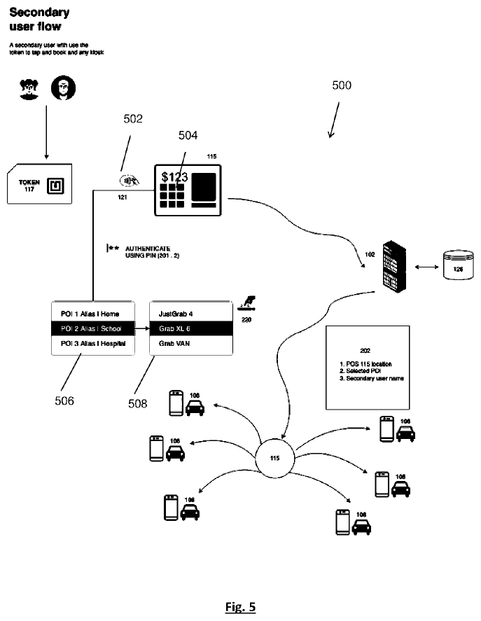

Further, it will be appreciated that FIGS. 3 and 5 illustrate and describe a method performed in a communication server apparatus 102, the method comprising, under control of a microprocessor 116 of the server apparatus 102:
storing a plurality of users, wherein one or more users having an associated payment method, and one or more of the one or more users having an associated payment method having an at least one associated unique non-payment passenger identifier, each associated unique non-payment passenger identifier having at least one predetermined destination address,
storing a plurality of booking communication devices, each booking communication device having a predetermined pickup location,
receiving one of the plurality of unique non-payment passenger identifiers, presented to one of the plurality of booking communication devices in relation to a booking,
determining an optimal transport solution for the booking based on at least the predetermined pickup location of the booking communication device, and on the predetermined destination address, and
initiating payment for the booking using the payment method associated with the respective user for the unique non-payment passenger identifier.

It is the general experience with taxis that certain locations may be hotspots, or have high demand in bookings. Traditionally this might be resolved by providing a taxi rank, or queue in such locations. The location may include a taxi hailing button to summon taxis, when none are present at the location.

More recently with ride hailing apps, booking pick up locations have become more ad hoc and a user can be picked up almost anywhere, given a precise GPS location provided by their phone. A user needs to activate the app, let it detect the pickup location by obtaining phone's GPS location, determine a candidate point of interest (POI) near that location and asking the user to enter a destination, before entering the booking stage.

However, if the user does not have a smartphone, clearly it is impossible for them to use the app at all; even if they do have a smartphone, it may be difficult for them to understand and navigate the booking flow, for example if the user is a child or elderly person.

According to one embodiment what is proposed is the use of booking hotspots across a given geographic market location. In each booking hotspot there would be a booking kiosk provided. This kiosk may be a custom designed booking communication device 115. Alternatively, the kiosk may be an existing third party digital kiosk, such as an ATM, ticket booking terminal, or information kiosk, with additional software loaded to provide the functionality of the booking communication device 115.

A sub user is defined as a passenger, who is unregistered within the transportation system. Users on the other hand are registered in the system. Each user may authorise the issuance of a token 117 which can be used for transport bookings in association with their account. The user may choose to provide one of these tokens to a sub user. This will allow the sub user to make transportation bookings, by presenting the token 117 to a booking communication device 115.

The process 300 for Signup is shown in FIG. 3:
User can authorize and request a token via their transportation system App of the user communication device 104.
While requesting 201 a token, the server 102 may generate an associated unique non-payment passenger identifier for the token (which may be a MAC address of the actual token or an identifier later mapped to that MAC address), and the user (with associated primary account identifier) may select:
   a pin for the sub user to authenticate with. The user can update this later as necessary.
   at least one predetermined destination address/POI to associate with each token. There may also be further predetermined destination address/POI selected for that token. The user can update this later as necessary.
   a nickname for the sub user, so that the driver can identify them if required. The user can update this later as necessary.
The server 102 then does a series of checks. First POI sanity check 202 against a set of rules to make sure the POI has been validly entered. Then there is a know your customer check 203, which checks the validity of the primary account holder's name, residential address, phone number and email. Then the payment method is checked 204 to ensure it is active and compatible. Lastly a final set of risk rules are checked 205 to minimise any fraud.
If the checks are successful the server associates the information above with the unique non-payment passenger identifier for the token in the database 126. The token 117 will be delivered 206 to the user's authorized address. The MAC address for the token 117 is associated in the database 126 with the unique non-payment passenger identifier. The user can then pass the token to the associated sub user and inform them of the pin.
If the checks are unsuccessful the user is informed of the error and can retry.

At any point if the user wishes to restrict or temporarily block any of the tokens, this can be done on the app of the user's communication device 104. This might be useful if one of the tokens is lost or temporarily misplaced. The user may also enter spending limits for each sub user, number of trips per day (or other period), or other limitations depending on the requirements of the application.

The booking device 115 or kiosk can be located in commonly used POIs, for example at airports, malls, schools, tourist landmarks, etc. Each kiosk has at least one scanner or reader for scanning a token (which may be a contactless device, NFC token, smartcard, or mobile device, barcode, QR code) that is encoded with a unique non-payment passenger identifier. The scanner/reader may be of the same type as used at point of sale (POS) terminals, for example.

The token 117 could be an NFC chip in a moulded casing, similar to “TraceTogether” token used for contact tracing in Singapore-https://onecms-res.cloudinary.com/image/upload/s-- |9a_JeQ--/c_fill%2Cg_auto%2Ch_468%2Cw_830/f_auto%2Cq_auto/singapore-covid-19-tracetogether-token --1-.jpg?itok=VXgkFWPO. Alternatively, the NFC chip could be provided within a mobile phone, a card, or any other housing.

Alternatively, or additionally a QR code can be printed on the casing surface of a token 117. In that case the booking kiosk would also have an optical scanner for scanning QR codes. As a further alternative, a QR code can be printed by user and/or sent electronically to user's phone and electronically displayed to the scanner. As such the token can be physical or virtual/electronic.

An example booking communication device 115 or kiosk 400 is shown in FIG. 4. If the token 117 is an NFC chip, then an NFC reader 121 is used to determine the unique non-payment passenger identifier. If the token 117 is an QR code, then a QR reader 411 is used to determine the unique non-payment passenger identifier. The unique non-payment passenger identifier is then stored in memory 404, and the cpu 406 makes a request to server 102 through the network 108. The cpu 406 may receive responses to the request and according to the programming instructions stored in the operating system 408 and the respective application 410, display relevant information on the user interface 119 for further action in booking transport. A POS printer 412 is included for receipts.

The process 500 for a sub user or passenger booking transportation is shown in FIG. 5:
A. Sub user taps 502 their token 117 (or scan if Qr based) to invoke the application.
B. The user may have to acknowledge terms and conditions of using the service. The user interface 119 displays a pin entry screen 504.
C. The cpu 406 makes a request to server 102 through the network 108 to validate the received token MAC address (or unique non-payment passenger identifier) and entered pin.
D. If authenticated, we map back to the user to whom the token belongs to.
E. The stored POI for that token and user are sent as a response back to the cpu 406.
F. The cpu 406 then causes the user interface 119 to display the respective stored POIs 506 and currently available transport types 508 for the user to select from.
G. A driver is optimally selected by the server 102 based on at least the kiosk location, the selected destination and selected transport type.
H. The cpu 406 may instruct the printer 412 to print a receipt including the driver's registration number and/or estimated ETA.
I . The user interface 119 may display the driver's ETA and/or track his progress to the kiosk or point of pickup.
J. An sms or notification with driver's details can be sent to the user's app with a link to track the driver on the way to the pickup location and/or during the trip.
F. Once the destination is reached charges will be paid using the user's selected payment method.

A user can request issuance of multiple tokens that can be associated with their account.

These can be used by e.g., the user's dependents to book a ride to a predetermined destination like Home, School, Aunt's place, etc; just by tapping or scanning at a nearby kiosk.

The token 117 may have following features:
Chip ID. (card or device with RFid/QR code)—this might also be called a unique non-payment passenger identifier. That is to say that the token does not store any payment information and is therefore more secure from direct fraud or financial theft.
Associated with a user account and associated payment method.
Associated with one or more predetermined destination(s).
Tapping this token at a booking communication device would book a ride using the user account payment method from the respective booking communication device location to the predetermined destination.

It will be appreciated that the invention has been described by way of example only. Various modifications may be made to the techniques described herein without departing from the spirit and scope of the appended claims. The disclosed techniques comprise techniques which may be provided in a stand-alone manner, or in combination with one another. Therefore, features described with respect to one technique may also be presented in combination with another technique.

1. A communication server apparatus for booking a transportation service, the communication server apparatus comprising a processor and a memory, the communication server apparatus being configured, under control of the processor, to execute instructions stored in the memory, to:
store in the memory, a plurality of users, wherein one or more users having an associated payment method, and one or more of the one or more users having an associated payment method having at least one associated unique non-payment passenger identifier, each associated unique non-payment passenger identifier having at least one predetermined destination address,
store in the memory a plurality of booking communication devices, each booking communication device having a predetermined pickup location,
receive one of the plurality of unique non-payment passenger identifiers, presented to one of the plurality of booking communication devices in relation to a booking,
determine using the processor an optimal transport solution for the booking based on at least the predetermined pickup location of the booking communication device and on the predetermined destination address retrieved from the memory, and
initiate payment for the booking using the payment method associated with the respective user for the unique non-payment passenger identifier.

2. The communication server apparatus of claim 1, wherein each unique non-payment passenger identifier is associated with a sub user.

3. The communication server apparatus of claim 2, wherein the communication server is configured to receive spending limits from a user in respect of the respective associated sub users.

4. The communication server apparatus of claim 2 wherein the communication server apparatus is configured to receive two or more predetermined destination addresses from a user in respect of the respective associated sub users.

5. The communication server apparatus of claim 4 configured to receive a selection from the passenger between two or more predetermined destination addresses, displayed on the booking communication device, corresponding to the presented unique non-payment passenger identifier.

6. The communication server apparatus of claim 4 configured to receive a selection from the passenger between multiple transportation types, and the optimal transport solution also being based on the selected transportation type.

7. The communication server apparatus of claim 1, wherein the communication server apparatus is configured to inform the user regarding each booking relating to an associated sub user.

8. The communication server apparatus of claim 1, wherein the communication server apparatus is configured to receive a request to disable a selected unique non-payment passenger identifier and to disable the selected unique non-payment passenger identifier from further bookings.

9. The communication server apparatus of claim 1, wherein the memory stores a PIN for each associated unique non-payment passenger identifier.

10. The communication server apparatus of claim 1, wherein the memory stores a Sub user Nickname for each associated unique non-payment passenger identifier.

11. A method performed in a communication server apparatus for booking a transportation service, the method comprising, under control of a processor of the communication server apparatus:
storing a plurality of users, wherein one or more users having an associated payment method, and one or more of the one or more users having an associated payment method having at least one associated unique non-payment passenger identifier, each associated unique non-payment passenger identifier having at least one predetermined destination address,
storing a plurality of booking communication devices, each booking communication device having a predetermined pickup location,
receiving one of the plurality of unique non-payment passenger identifiers, presented to one of the plurality of booking communication devices in relation to a booking,
determining an optimal transport solution for the booking based on at least the predetermined pickup location of the booking communication device and on the predetermined destination address retrieved from the memory, and
initiating payment for the booking using the payment method associated with the respective user for the unique non-payment passenger identifier.

12. (canceled)

13. A non-transitory storage medium, storing instructions, which when executed by a processor, causes the processor to perform the method of claim 11.

14. A booking communication device for communicating with a communication server, the booking communication device comprising a processor and a memory, the booking communication device being configured, under control of the processor, to execute instructions stored in the memory to:
receive a unique non-payment passenger identifier in relation to a booking,
send the unique non-payment passenger identifier to a communication server apparatus,
receive at least one predetermined destination address, the at least one predetermined destination address, in the communication server apparatus, associated with the unique nonpayment passenger identifier,
receive user input confirming the booking including the predetermined destination address,
send a request for an optimal transport solution for the booking based on at least a predetermined pickup location of the booking communication device, and the predetermined destination address.

15. A communication system, comprising:
a communication server;
at least one booking communication device in a predetermined pickup location; and
communication network equipment configured to establish communication with the communication server and the at least one booking communication device;
wherein the booking communication device comprises a first processor and a first memory, the booking communication device being configured, under control of the first processor, to execute first instructions stored in the first memory to:
receive a unique non-payment passenger identifier presented to the booking communication device in relation to a booking, and
send the unique non-payment passenger identifier to the communication server together with the predetermined pickup location or an identifier corresponding to the respective booking communication device;
and wherein the communication server comprises a second processor and a second memory, the communication server being configured, under control of the second processor, to execute second instructions stored in the second memory to:
store in the second memory a plurality of users, wherein one or more users having an associated payment method, and one or more of the one or more users having an associated payment method having at least one associated unique non-payment passenger identifier, each associated unique non-payment passenger identifier having at least one predetermined destination address,
determine using the second processor an optimal transport solution for the booking based on the predetermined pickup location of the booking communication device, and on the predetermined destination address retrieved from the second memory, and initiate payment for the booking using the payment method associated with the respective user for the unique non-payment passenger identifier.
